(19) United States
(12) Patent Application Publication
(10) Pub. No.: US 2023/0324875 A1
(43) Pub. Date: Oct. 12, 2023

(54) Encoder, Motor, Motor Drive and Host Computer

(71) Applicant: Siemens Aktiengesellschaft, München (DE)

(72) Inventors: Lei Cui, Nanjing (CN); Bo Yan, Jiangning Development Zone, Nanjing (CN); Er Ping Meng, Jiangning Development Zone, Nanjing (CN); Jun Li Ji, Jiangning Development Zone, Nanjing (CN); Dian Song, Nanjing (CN); Ning Zhao, Jiangning Development Zone, Nanjing (CN)

(73) Assignee: Siemens Aktiengesellschaft, München (DE)

(21) Appl. No.: 18/041,349

(22) PCT Filed: Aug. 13, 2020
(86) PCT No.: PCT/CN2020/108974

§ 371 Date: Feb. 10, 2023

(51) Int. Cl. G05B 19/4062

(52) U.S. Cl. CPC G05B 19/4062

(57) ABSTRACT

Various embodiments include an encoder for a motor. The encoder may include: a sensor module for collecting sensor data of the motor with a sensor while the motor is running; a storage module storing motor running records; and a microcontroller unit. The microcontroller is programmed to determine a running state of the motor using the sensor data, storing information about the running state into the storage module as a motor running record in response to a determination that the running state is a predefined running state, and providing at least one of the motor running records stored in the storage module via a communication interface in response to a reading request received from the communication interface.

### CROSS-REFERENCE TO RELATED APPLICATIONS

This application is a U.S. National Stage Application of International Application No. PCT/CN2020/108974 filed Aug. 13, 2020, which designates the United States of America, the contents of which are hereby incorporated by reference in their entirety.

### TECHNICAL FIELD

The present disclosure relates to motors. Various embodiments of the teachings herein include encoders, motors, motor drives and/or host computers.

### BACKGROUND

At present, many motors have integrated encoders. An encoder can monitor the motor’s actual position, and provide feedback to the drive (or controller) of the motor, so that the motor drive can perform position verification, and even stall detection, of the motor. As such, the addition of an encoder can make a motor system more robust and achieve better performances.

### SUMMARY

In order to address at least some of disadvantages of current encoders or motors, the teachings of the present disclosure include encoders, motors, motor drives, and/or host computers to facilitate maintenance and repair of motors. For example, some embodiments include an encoder (10), applicable to a motor (20), comprising: a sensor module (13), capable of collecting sensor data of a motor (20) using at least one sensor when the motor (20) is running; a storage module (16), capable of storing motor (20) running records; and a microcontroller unit (11), capable of determining a running state of the motor (20) using the sensor data, storing information about the running state into the storage module (16) as a motor running record in response to a determination that the running state is a pre-defined running state, and providing at least one of the motor running records stored in the storage module (16) via a communication interface (14) in response to a reading request received from the communication interface (14).

In some embodiments, the microcontroller unit (11) is further capable of receiving a recording request from a device, storing information specified by the recording request into the storage module (16) as a motor running record.

In some embodiments, the device is a drive (30) of the motor (20), the information specified by the recording request is information about an abnormality of the motor (20) detected by the drive.

In some embodiments, the device is a host computer (40), the information specified by the recording request is information about a maintenance operation on the motor (20) generated by the host computer (40).

In some embodiments, the microcontroller unit (11) is further capable of recording time information indicating a time point when each motor running record is stored.

In some embodiments, the microcontroller unit (11) is capable of recording an accumulative service time by counting clock signals of the microcontroller unit (11) while the encoder (10) is powered on, and storing into a motor running record the accumulative service time on record when storing the motor running record into the storage module (16).

In some embodiments, the encoder further comprises: a real-time clock module (18), capable of counting date and time; wherein the microcontroller unit (11) is capable of recording a date and a time obtained from the clock module into a motor running record when the motor running record is stored.

In some embodiments, the storage module (16) further stores a maintenance period of the motor (20); and the microcontroller unit (11) is further capable of determining an accumulative running time which indicates a total time length the motor (20) has been running accumulatively since a previous maintenance, and providing a maintenance alert to a device in response to a determination that an accumulative running time reaches the maintenance period.

In some embodiments, the storage module (16) further stores service life of the motor (20); and the microcontroller unit (11) is further capable of determining an accumulative service time which indicates a total time length the motor (20) has been running accumulatively since the motor (20) is put into use, and providing a replace-motor alert to a device in response to a determination that the accumulative service time reaches the service life.

In some embodiments, the storage module (16) further stores parameters of the motor (20); and the microcontroller unit (11) is further capable of providing the parameters of the motor (20) stored in the storage module (16) through a communication interface (14) in response to a parameter request received from the communication interface (14).

In some embodiments, the storage module (16) comprises a storage chip, mounted to a circuit board (12) of the encoder (10), connected to a serial communication interface (14) of a chip serving as the microcontroller unit (11).

In some embodiments, the storage module (16) comprises storage circuits in a chip serving as the microcontroller unit (11).

In some embodiments, the microcontroller unit (11) is further capable of, in response to a record restoring command received from a device, downloading motor running records from the device into the storage module (16) as restored motor running records.

In some embodiments, the real-time clock module (18) is a real-time clock chip mounted to a circuit board (12) of the encoder (10), and is connected to a serial communication interface of a chip serving as the microcontroller unit (11); and the circuit board (12) provides a battery interface (172) capable of delivering power from a battery to the real-time clock module (18).

In some embodiments, the microcontroller unit (11) is further capable of detecting a voltage of the battery, and providing a replace-battery alert to a device in response to a determination that the voltage of the battery is below a pre-defined voltage threshold.

As another example, some embodiments include a motor (20), comprising an encoder (10) as described herein.

As another example, some embodiments include a motor drive (30), comprising a drive controller, capable of detecting an abnormality of a motor (20), and sending information about the abnormality to an encoder (10) which stores the information as a motor running record.

In some embodiments, the drive controller is further capable of sending a parameter request to the encoder (10), configures settings of the motor drive using parameters returned by the encoder (10).

As another example, some embodiments include a host computer (40), comprising a host controller (46), capable of sending a reading request to a communication interface (14) of an encoder (10), and presenting at least one motor running record returned by the encoder (10) using a display device.

In some embodiments, the host controller (46) is further capable of receiving maintenance information from an input device, and sending the maintenance information to the encoder (10) which stores the maintenance information as a motor running record.

In some embodiments, the host controller (46) is further capable of reading all of motor running records from a first encoder (10), and storing the motor running records into the second encoder (10) as restored motor running records.

As another example, some embodiments include a computer readable storage medium, storing computer-readable instructions executable by a processor to implement a host computer (40) as described herein.

### BRIEF DESCRIPTION OF THE DRAWINGS

The teachings of the present disclosure are described in further detail hereinafter with reference to accompanying drawings and examples. In the following description, numerous specific details are set forth in order to provide a thorough understanding of the present disclosure. It will be readily apparent however, that the present disclosure may be practiced without limitation to these specific details. In other instances, some functions, methods and structures have not been described in detail so as not to unnecessarily obscure the present disclosure. In the drawings:

FIGS. 1A and 1B are two examples of a system which includes a motor incorporating teachings of the present disclosure;

FIG. 2 is a schematic diagram illustrating an encoder incorporating teachings of the present disclosure;

FIG. 3 is a flowchart illustrating a process performed by the encoder incorporating teachings of the present disclosure;

FIG. 4 is a flowchart illustrating an encoder providing a time-related alert function incorporating teachings of the present disclosure;

FIG. 5 is a schematic diagram illustrating an encoder incorporating teachings of the present disclosure;

FIG. 6 is a schematic diagram illustrating a motor system incorporating teachings of the present disclosure;

FIG. 7 is a flowchart illustrating a time-related alert functions of an encoder with a real-time clock module having a calendar function incorporating teachings of the present disclosure; and

FIG. 8 is a schematic diagram illustrating a host computer incorporating teachings of the present disclosure.

List of reference numbers:

| Reference numbers | Meanings |
|---|---|
| 10 | encoder |
| 20 | motor |
| 30 | motor drive |
| 40 | host computer |
| 31, 32, 41, 43 | connections |
| 50 | industrial network controller |
| 55 | industrial network bus |
| 11 | microcontroller unit |
| 12 | circuit board |
| 13 | sensor module |
| 14 | communication interface |
| 16 | storage module |
| 17 | power selection module |
| 171 | external power interface |
| 172 | battery interface |
| 18 | real-time clock module |
| S31~S34, S40~47, S70~S78 | method procedures |
| 51 | processor |
| 52 | memory |
| 53 | communication module |
| 54 | operating system |
| 55 | communication processing module |
| 56 | host controller |

### DETAILED DESCRIPTION

Various embodiments provide an encoder applicable to a motor. The encoder may include: a sensor module, capable of collecting sensor data of a motor using at least one sensor when the motor is running; a storage module, capable of storing motor running records; and a microcontroller unit, capable of determining a running state of the motor using the sensor data, storing information about the running state into the storage module as a motor running record in response to a determination that the running state is a pre-defined running state, and providing at least one of the motor running records stored in the storage module via a communication interface in response to a reading request received from the communication interface.

Since encoders are generally integrated into motors to be together with the motor all through the service life of the motor, records of performances of the motor stored in the encoder are also with the motor all the time and can be obtained whenever needed without having to rely on manual notes placed elsewhere. For example, a buyer of a second-hand motor can get information about the service history of the motor from the encoder even if manual notes about the history of the motor is not available from the previous owner of the motor. As such, the encoder can facilitate maintenance and repair of the motor.

In some embodiments, the microcontroller unit may also be capable of receiving a recording request from a device, storing information specified by the recording request into the storage module as a motor running record. As such, the encoder can record more information about the motor besides the information detected by the encoder.

In some embodiments, the device may be a drive of the motor, and the information specified by the recording request may be information about an abnormality of the motor detected by the drive. As such, the encoder is able to record motor abnormalities which are beyond the detection capabilities of the encoder, such as abnormalities in the voltage or current of the motor, and provide more comprehensive information about the performances of the motor.

In some embodiments, the device may be a host computer, and the information specified by the recording request may be information about a maintenance operation on the motor generated by the host computer. As such, the encoder can record maintenance information of the motor besides abnormalities, and such information can be especially informative for future maintenance or repair of the motor.

In some embodiments, the microcontroller unit may also be capable of recording time information indicating a time point when each motor running record is stored. By recording the time of each motor running record, the encoder can provide a timeline of performance history of the motor, thus facilitates future maintenance or repair of the motor.

In some embodiments, the microcontroller unit is capable of recording an accumulative service time by counting clock signals of the microcontroller unit while the encoder is powered on, and storing into a motor running record the accumulative service time on record when storing the motor running record into the storage module. By recording the accumulative time length when each motor running record is stored, the encoder can provide information about the time points in the service life of the motor at which the records are stored, thus facilitates understanding of the conditions of the motor by a technical person.

In some embodiments, the encoder may include a real-time clock module, capable of counting date and time. The microcontroller unit may be capable of recording a date and a time obtained from the clock module into a motor running record when the motor running record is stored. By recording the date and time when each motor running record is stored, the encoder can provide clear date and time information about the records, thus facilitates understanding of the conditions of the motor by a technical person.

In some embodiments, the storage module may also store a maintenance period of the motor; the microcontroller unit may also be capable of determining an accumulative running time which indicates a total time length the motor (20) has been running accumulatively since a previous maintenance, and providing a maintenance alert to a device in response to a determination that the accumulative running time reaches the maintenance period. By monitoring the maintenance period of the motor, the encoder can provide alerts when the motor needs maintenance, thus can ensure the motor get proper maintenance, which can keep the motor in good condition and prolong the service life of the motor.

In some embodiments, the storage module may also store service life of the motor; the microcontroller unit may also be capable of determining an accumulative service time which indicates a total time length the motor (20) has been running accumulatively since the motor (20) is put into use, and providing a replace-motor alert to a device in response to a determination that the accumulative service time reaches the service life. By monitoring the service life of the motor, the encoder can provide alerts when the motor needs to be replaced, thus can ensure the system to function properly and safely, thus improve the performances of the system.

In some embodiments, the storage module may also store parameters of the motor; the microcontroller unit may also be capable of providing the parameters of the motor stored in the storage module through a communication interface in response to a parameter request received from the communication interface. By storing parameters of the motor, the encoder can provide the parameters on request, thus any device or person can obtain information about the motor from the encoder without keeping a hard copy of a manual of the motor after purchasing the motor.

In some embodiments, the storage module may include: a storage chip, mounted to a circuit board of the encoder, connected to a serial communication interface of a chip serving as the microcontroller unit. As such, the encoder can have a large storage space by using a storage chip.

In some embodiments, the storage module may include: storage circuits in a chip serving as the microcontroller unit. As such, using storage space in the microcontroller chip can reduce the physical size of the encoder.

In some embodiments, the microcontroller unit may also be capable of, in response to a record restoring command received from a device, downloading motor running records from the device into the storage module as restored motor running records. As such, the encoder is capable of downloading motor running records in batch, which is useful when the encoder is installed in to a motor to replace a previous encoder, thus the history of the motor can be recovered in another encoder and will not be lost when an encoder in a motor is not working and replaced.

In some embodiments, the real-time clock module may be a real-time clock chip mounted to a circuit board of the encoder, and is connected to a serial communication interface of a chip serving as the microcontroller unit; the circuit board provides a power supply interface capable of delivering power from a battery to the real-time clock module. As such, by using a RTC chip and a battery interface, the encoder can be enabled to continuously record date and time even if the motor is powered off.

In some embodiments, the microcontroller unit may also be capable of detecting a voltage of the battery, and providing a replace-battery alert to a device in response to a determination that the voltage of the battery is below a pre-defined voltage threshold. Therefore, the encoder can ensure the continuous functioning of the real-time clock chip, and the user of the motor does not have to worry about forgetting to change the battery.

In some embodiments, there is a motor which includes an encoder incorporating teachings of the present disclosure. Various embodiments also provide a motor drive which may include a drive controller, capable of detecting an abnormality of a motor, and sending information about the abnormality to an encoder which stores the information as a motor running record. The motor drive can make abnormalities of the motor detected by the motor drive recorded in the encoder so as to be with the motor all the time and can be obtained whenever needed, thereby facilitates maintenance and repair of the motor.

In some embodiments, the drive controller may also be capable of sending a parameter request to the encoder, configures settings of the motor drive using parameters returned by the encoder. By obtaining parameters of the motor from the encoder of the motor, the motor drive can perform automatic self-configuration when connected to the motor without manual configuration procedures, thus the configuration of the motor drive can be simplified and less time-consuming.

In some embodiments, there is a host computer which may include a host controller, capable of sending a reading request to a communication interface of an encoder, and presenting at least one motor running record returned by the encoder using a display device. It can be seen that, the host computer can read running state records of the motor from the encoder and present the same, thereby facilitates maintenance and repair of the motor.

In some embodiments, the host controller may also be capable of receiving maintenance information from an input device, and sending the maintenance information to the encoder which stores the maintenance information as a motor running record. As such, the host computer can record information inputted by a technical person into the encoder of the motor, e.g., the change of a part of the motor, or a certain maintenance operation done to the motor, to facilitate future maintenance or repair of the motor.

In some embodiments, the host controller may also be capable of reading all of motor running records from a first encoder, and storing the motor running records into the second encoder as restored motor running records. As such, when an encoder in a motor is not working and replaced, the host computer can read all the motor running records from the previous encoder and storing the motor running records into the new encoder, thus the history of the motor can be recovered in the new encoder and will not be lost.

In some embodiments, there is a computer readable storage medium, storing computer-readable instructions executable by a processor to implement the host computer according to any one of the embodiments.

As used herein, the term “includes” means includes but not limited to, the term “including” means including but not limited to. The term “based on” means based at least in part on. In addition, the terms “a” and “an” are intended to denote at least one of a particular element.

As used in this disclosure, a motor may refer to an electric motor of any type, e.g., AC brushless motor, DC brushless motor, direct drive motor, linear motor, servo motor, stepper motor, etc., that are suitable for use in various embodiments.

A motor drive, also referred to as drive or controller of a motor herein, refers to an apparatus for controlling the speed, the torque and the direction of a motor to generate horsepower of the motor. The motor drive may detect an abnormality of the motor using information gathered by the motor drive, e.g., a current of the motor, or sensor data received from an encoder, and present an alert using, for example, a light or a sound, or send an alert message to a host computer. The drive as used in this disclosure may be any drive that matches to the motor used. The drive may be a standalone device, or may be a component integrated into the motor.

An encoder, also referred to as motor encoder herein, refers to a rotary encoder mounted to the motor that provides closed loop feedback signals (also referred to as sensor data) by tracking the speed and/or position of a shaft or a rotor or a gear wheel of the motor. The encoder may be any suitable encoder, e.g., photoelectric encoder, capacitive-grid encoder, magnetoelectric encoder, or the like.

A host computer, also referred to as host or PC-based controller, refers to a computer used in a motor system for supporting system management, man-machine interface, movement trajectory planning, and command to send and receive.

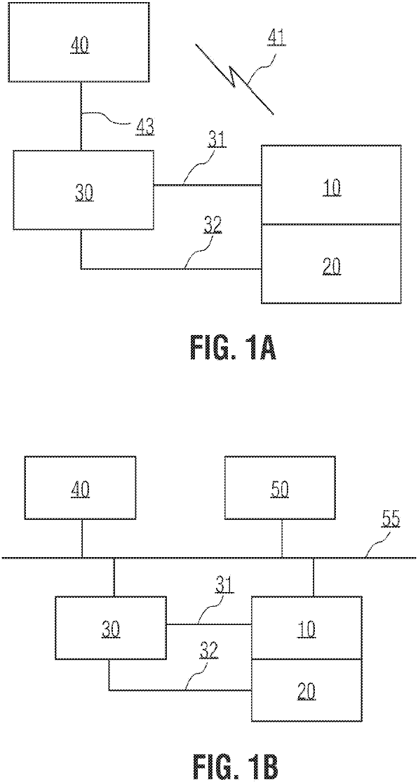

FIGS. 1A and 1B are two examples of a system which includes a motor incorporating teachings of the present disclosure. As shown in FIG. 1A, the system includes a motor 20 for a certain task. The motor 20 may be controlled by a motor drive 30 through a connection 32 which may be a power supply cable. The motor drive 30 is capable of communicating with a host computer 40 through a connection 43. The motor 20 has a built-in encoder 10. The encoder is capable of communicating with the motor drive 30 through a connection 31, and with a host computer 40 through the motor drive 30 or a connection 41.

Each of the connections 31, 41 and 43 may be a wired or wireless connection, may be a direct communication connection or an indirect communication connection through another device or a network. Each of the connections 31, 41 and 43 may be established between communication interfaces or interfaces conforming to a respective communication protocol, and information transported through the connection may be arranged in a format specified in a pre-defined communication protocol. The communication protocol may be any suitable communication protocol, e.g., a standard communication protocol, or a private communication protocol, or the like.

As shown in FIG. 1B, the system includes one or multiple motors 20 (only one depicted) for one or multiple tasks. The motor 20 may be controlled by a motor drive 30 through a connection 32. The motor 20 has a built-in encoder 10. The system also includes an industrial network bus 55 and an industrial network controller 50 responsible for enabling communications between devices connected to the industrial network bus 55. The motor drive 30 and the host computer 40 may be connected to the industrial network bus 55. The encoder is capable of communicating with the motor drive 30 through a connection 31 or through the industrial network bus 55 when the encoder 20 is connected to the industrial network bus 55. The encoder is capable of communicating with the host computer 40 through the motor drive 30 or through the industrial network bus 55 when the encoder 20 is connected to the industrial network bus 55.

FIGS. 1A and 1B are merely examples of the deployment manner of the devices. In various embodiments, the devices may be deployed in other manners to present different system structures.

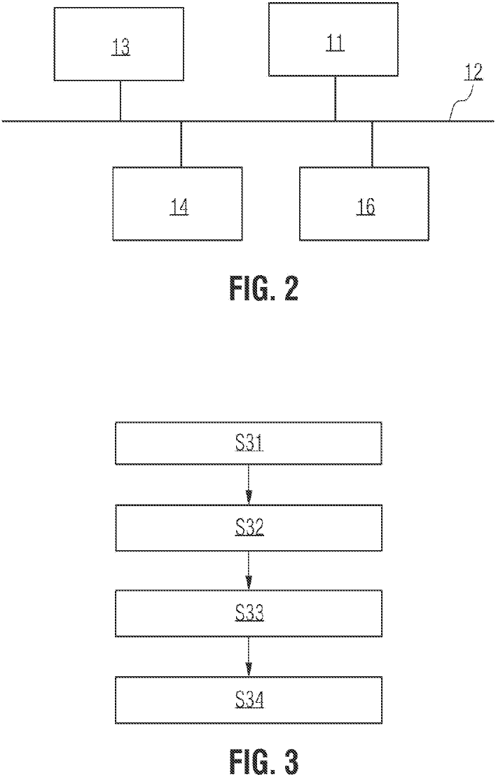

In some embodiments, the encoder 10 is capable of storing information about the motor 20 and providing the information to the motor drive 30 or the host computer 40. FIG. 2 is a schematic diagram illustrating an encoder 10 according to an embodiment of the present disclosure. As shown in FIG. 2, the encoder 10 may include a microcontroller unit (or MCU) 11, a sensor module 13, a communication interface 14, a storage module 16, and a circuit board 12 for connecting the modules.

In some embodiments, the circuit board 12 may be a printed circuit board (PCB) including conductive tracks to electrically connect components mounted to the circuit board 12.

In some embodiments, the communication interface 14 provides one or multiple physical communication interfaces for communicating information with one or multiple devices. The communication interface may be any type of communication interface that match to the communication connection adopted. For example, the communication interface may include, but not limited to, a BiSS interface, a Synchronous Serial Interface (SSI), a RS-485 interface, a wireless communication interface, an EtherNet/IP interface, a Profibus interface, a CAN interface, a modbus interface, or the like.

The sensor module 13 is capable of collecting sensor data of a motor using at least one sensor when the motor is running. The sensor module 13 may include one or multiple sensors for detecting the rotational movement of a shaft or a gear wheel of the motor. The sensors may be any suitable rotational sensors, e.g., temperature sensors, magnetic sensors, photo sensors, or the like.

In some embodiments, the microcontroller unit 11 may be a microcomputer chip for processing data sent and received by the encoder 10. The microcontroller unit 11 may be implemented by, for example, a Single-Chip Microcomputer, a digital signal processor (DSP), a field programmable gate array (FPGA), an application-specific integrated circuit (ASIC), or the like. The MCU 11 is capable of determine a running state of the motor using the sensor data from the sensor module 13, storing information about the running state into the storage module 16 as a motor running record in response to a determination that the running state is a pre-defined running state, and providing at least one of the motor running records stored in the storage module 16 via a communication interface in response to a reading request received from the communication interface. The pre-defined running state may be one of pre-set running states of concern. The pre-set running state may be, for example, power-on, power-off, an abnormal state (e.g., overheat, stall), or the like.

The storage module 16 is capable of storing motor running records. In some embodiments, the storage module 16 may include a storage chip mounted to the circuit board 12. For example, the storage chip may include, but not limited to, FLASH memory chip, SRAM chip, or the like. In some embodiments, the storage module 16 may include storage circuits in the chip of the MCU 11.

FIG. 3 is a flowchart illustrating a process performed by the encoder 10 incorporating teachings of the present disclosure. As shown in FIG. 3, the method may include the following procedures.

At block S31, the encoder 10 collects sensor data of a motor 20 using at least one sensor when the motor 20 is running. The sensor data may be electric signals generated by the at least one sensor under impact of the rotation of a shaft or a gear wheel of the motor 20.

At block S32, the encoder 10 determines a running state of the motor 20 using the sensor data. For example, the encoder 10 may determine a temperature of the motor 20 using the sensor data, and compares the temperature with a pre-defined threshold to determine the running state of the motor 20. For example, the MCU 11 may convert the electric signals from the sensor module 13 into a temperature, and judge whether the temperature is within a pre-defined temperature range. When the temperature is within the pre-defined temperature range, the MCU 11 may determine the running state of the motor is normal. When the rotation speed is out of the pre-defined temperature range, the MCU 11 may determine the running state of the motor is abnormal or overheat.

At block S33, the encoder 10 stores information about the running state as a motor running record in the storage module 16 in response to a determination that the running state is a pre-defined running state. The information about the running state may include, for example, at least one of: the running state, the name of the parameter whose value is detected to be abnormal and the abnormal value, the temperature of the motor, a rotor position, or the like. In an example, in response to a detection that the temperature of the motor 20 exceeds a pre-defined upper threshold, the MCU 11 may determine the running state of the motor 20 is overheat, and may create and store a motor running record which may include information indicating the running state of “overheat” and the temperature. In another example, in response to a detection that the motor 20 stops rotating, the MCU 11 may determine the running state of the motor 20 is stop, and may create and store a motor running record which may include information indicating the running state of “stop” and the rotor position at which the motor stops. The motor running record may be in any suitable form, e.g., text, a numerical string, an entry in a list, or the like.

In response to a detection of the change in the running state or that the sensor data meets a pre-defined condition, the encoder 10 may also send an alert signal to the drive 30 and/or the host computer 40.

At block S34, the encoder 10 provides at least one of motor running records stored in the storage module 16 via a communication interface in response to a reading request received from the communication interface. The reading request may conform to a message format defined in a pre-determined communication protocol. After correctly parsing the reading request, the encoder 10 may return the motor running records specified by the reading request via the communication interface that receives the reading request. In an example, the reading request may include information specifying at least one motor running record, e.g., the most recent record, the latest 5 records, all records, or the like.

In the example as shown in FIG. 1A, the host computer 40 may send a request to the motor drive 30 through the connection 43 to make the motor drive 30 send a reading request to the encoder 10 through the connection 31. In such case, the encoder 10 may send the requested motor running record through a communication interface leading to the connection 31 to the motor drive 30 which forwards the record to the host computer 40. In another example, the host computer 40 may send the reading request to the encoder 10 through the connection 41, and the encoder 20 may feedback the requested motor running record through a communication interface leading to the connection 41 to the host computer 40.

It can be seen that, since encoders are generally integrated into motors to be together with the motor all through the service life of the motor, records of performances of the motor stored in the encoder are also with the motor all the time and can be obtained whenever needed without having to rely on manual notes placed elsewhere. For example, a buyer of a second-hand motor can get information about the service history of the motor from the encoder even if manual notes about the history of the motor is not available from the previous owner of the motor. As such, the encoder can facilitate maintenance and repair of the motor.

In some embodiments, the encoder 10 is enabled to store information of the motor 10 by using the storage module 16, thus can provide information of the motor for facilitating maintenance or repair of the motor 10. In practice, some information generated by other devices may be also useful in motor maintenance and repair, for example, abnormality information detected by the motor drive 30, or information about a maintenance operation done by a technical person. The encoder 10 of some embodiments is capable of generating and storing a motor running record using information received from another device.

In such an encoder 10, the microcontroller unit 11 may also be capable of receiving a recording request from a device, storing information specified by the recording request into the storage module 16 as a motor running record. As such, the encoder 10 can record more information about the motor besides the information detected by the encoder.

In some embodiments, the device may be the drive 30 of the motor, and the information specified by the recording request may be information about an abnormality of the motor detected by the drive 30. For example, in response to a detection of overcurrent of the motor 20, the drive 30 may generate an alert, and send information about the overcurrent to the encoder 10. The MCU 11 of the encoder 20 may generate a motor running record which indicates a running state of “overcurrent”, and the current value if any, and store the newly generated motor running record into the storage module 16. As such, the encoder 10 is able to record motor abnormalities which are beyond the detection capabilities of the encoder 10, such as abnormalities in the voltage or current of the motor 20, and provide more comprehensive information about the performances of the motor 20.

In some embodiments, the device may be the host computer 40, and the information specified by the recording request may be information about a maintenance operation on the motor 20 generated by the host computer 40. For example, the host computer 40 may present a user interface and receive information inputted by the technician as a maintenance record, the information indicates a sealing ring or a brake in the motor 20 is replaced in a maintenance procedure. The host computer 40 may send the maintenance record in a recording request to the encoder 10. The MCU 11 of the encoder 20 may generate a motor running record which includes the maintenance record in the recording request, and store the newly generated motor running record into the storage module 16. As such, the encoder can record maintenance information of the motor besides abnormalities, and such information can be especially informative for future maintenance or repair of the motor.

Besides the listing of abnormality or maintenance events, the time of the events may also be important. In some embodiments, the encoder 10 is also capable of recording the time of the events, i.e., the time of storing each of the motor running records. That is, the microcontroller unit 11 may also be capable of recording time information indicating a time point when each motor running record is stored. By recording the time of each motor running record, the encoder can provide a timeline of performance history of the motor, thus facilitates future maintenance or repair of the motor.

In some embodiments, the microcontroller unit 11 may be capable of recording an accumulative service time by counting of clock signals of the microcontroller unit 11 while the encoder 10 is powered on, and storing into a motor running record the accumulative service time on record when storing the motor running record into the storage module 16. The microcontroller unit 11 may take advantage of a built-in oscillator which can generate periodical clock signals to record the accumulative service time of the motor 20. After the encoder 10 is powered on, the microcontroller unit 11 may begin to generate and count the clock signals, and continuously updating the accumulative service time of the motor 20. When the encoder 10 is powered off, the microcontroller unit 11 may stop updating the accumulative service time. The accumulative service time may be stored within the microcontroller unit 11 or in the storage module 16. As such, the encoder 10 is capable of recording time information of each motor running record by using the recorded real-time accumulative service time of the motor.

In some embodiments, the microcontroller unit 11 may be capable of determining the current value of the accumulative service time in response to a determination that a motor running record is to be stored, and storing the current value of the accumulative service time into the motor running record. For example, after the motor 20 and the encoder 10 are powered on, power is supplied to the microcontroller unit 11, and an oscillator in the microcontroller unit 11 may begin to provide periodical clock signals, e.g., sending one clock signal every pre-set time interval that is decided by the oscillation frequency of the oscillator. The microcontroller unit 11 may maintain a count of the clock signals as the accumulative service time or a time length value calculated using the count as the accumulative service time.

When a motor running record is stored, the microcontroller unit 11 may identify the current clock signal count or the current accumulative service time (e.g., “326:45:01” (hour: minute: second)), and store the current value of the accumulative service time into the motor running record. As such, by recording the accumulative time length when each motor running record is stored, the encoder can provide information about the time points in the service life of the motor at which the records are stored, thus facilitates understanding of the conditions of the motor by a technical person.

In some embodiments, the encoder 10 is capable of counting the accumulative service time and the encoder 10 may provide many other time-related functions besides recording the time information of each motor running record. The following are a few of the examples.

In some embodiments, the storage module 16 may also store a maintenance period of the motor; the microcontroller unit 11 may also be capable of determining an accumulative running time which indicates a total time length the motor 20 has been running accumulatively since a previous maintenance, and providing a maintenance alert to a device in response to a determination that the accumulative running time of the motor reaches the maintenance period.

In some embodiments, the microcontroller unit 11 may determine the accumulative running time by updating a count of clock signals or by updating an accumulative time length value, or the like, using clock signals provided by a built-in oscillator while the encoder 10 is powered on. The maintenance alert may be a pre-defined signal, or may conform to a pre-defined message format which includes information indicating the motor needs maintenance. The maintenance alert may be provided to at least one of the motor drive 30 and the host computer 40. After a maintenance, the accumulative running time may be reset in response to a signal or a message received, e.g., via a physical button provided by the encoder or from the host computer 40.

As such, by monitoring the maintenance period of the motor, the encoder can provide alerts when the motor needs maintenance, thus can ensure the motor get proper maintenance, which can keep the motor in good condition and prolong the service life of the motor.

In some embodiments, the storage module 16 may also store service life of the motor; the microcontroller unit 11 may also be capable of determining an accumulative service time which indicates a total time length the motor 20 has been running accumulatively since the motor 20 is put into use, and providing a replace-motor alert to a device in response to a determination that the accumulative service time reaches the service life.

In some embodiments, the microcontroller unit 11 may determine the accumulative service time by updating a count of clock signals or by updating an accumulative time length value, or the like, using clock signals provided by a built-in oscillator while the encoder 10 is powered on. The service life refers to the maximum working hours of the motor before the motor should be discarded. The replace-motor alert may be a pre-defined signal, or may conform to a pre-defined message format which includes information indicating the motor needs to be replaced. The replace-motor alert may be provided to at least one of the motor drive 30 and the host computer 40.

By monitoring the service life of the motor, the encoder can provide alerts when the motor needs to be replaced, thus can ensure the system to function properly and safely, thus improve the performances of the system.

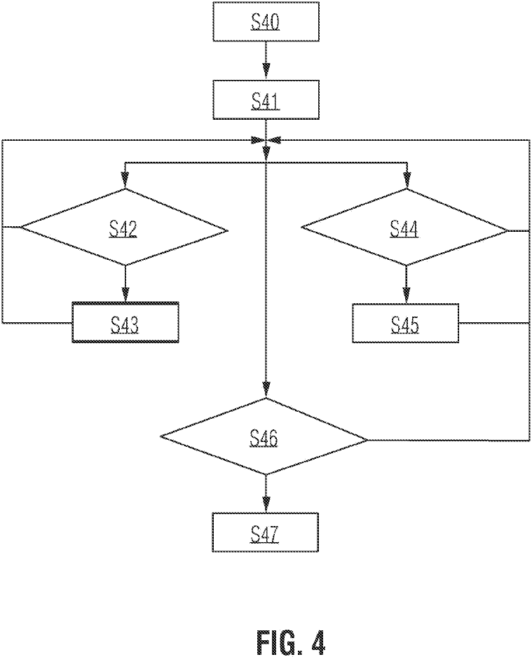

FIG. 4 is a flowchart illustrating a time-related alert functions of an encoder 10 with a real-time clock module 18 without a calendar function incorporating teachings of the present disclosure. As shown in FIG. 4, the method may include the following procedures.

At block S40, the encoder 10 is powered on.

At block S41, the MCU 11 may continuously update an accumulative running time and an accumulative service time of the motor 20 using clock signals from an oscillator of the MCU 11.

At block S42, the MCU 11 may determine whether the accumulative running time reaches a maintenance period stored in the storage module 16.

At block S43, the MCU 11 may provide a maintenance alert in response to a determination that the accumulative running time reaches or exceeds the maintenance period.

At block S44, the MCU 11 may determine whether the accumulative service time reaches a service life stored in the storage module 16.

At block S45, the MCU 11 may provide a replace-motor alert in response to a determination that the accumulative service time reaches the service life.

At block S46, the MCU 11 may determine whether the encoder 10 is powered off.

At block S47, the MCU 11 may suspend updating the accumulative running time and the accumulative service time.

In some embodiments, the microcontroller unit 11 may also be capable of obtaining time information from another component of the encoder 10. FIG. 5 is a schematic diagram illustrating an encoder 10 according to an embodiment of the present disclosure. As shown in FIG. 5, the encoder 10 may also include a real-time clock module 18. The real-time clock module 18 may be a chip mounted to the circuit board 12 for providing time information to the MCU 11.

In some embodiments, the chip may be connected to a serial communication interface of a chip which serves as the microcontroller unit 11. The chip may be any suitable chip that can provide suitable time information. In some embodiments, the chip may be a real-time clock (RTC) chip providing clock signals at pre-defined time intervals.

In some embodiments, the chip may be an RTC chip with calendar functions, i.e., the RTC chip can continuously count the date and time. Such calendar functions require continuous power supply, thus in such examples, the circuit board 12 may provide a battery interface for receiving a battery and deliver the power from the battery to the RTC chip. In some examples, the battery interface may be a slot on the circuit board 12 for receiving a battery. For example, such battery interface may be configured in an encoder 10 used in a detachable maintenance motor (e.g. a high-speed spindle motor) whose case can be opened for maintenance. In some other examples, the battery interface may be a battery box connected to the circuit board 12 through wires that extends out of the housing of the motor, so that replacing the battery does not require opening the housing of the motor. Such battery interface is especially advantageous for an encoder 10 used in an undetachable maintenance motor (e.g. servo motor) whose case cannot be opened for maintenance.

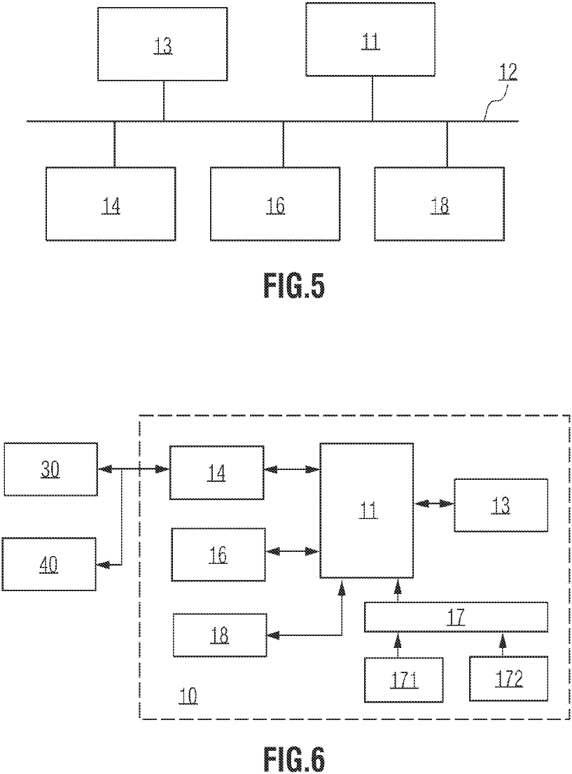

When there is a battery interface in the encoder 10, the encoder 10 may also include a power selection module. FIG. 6 is a schematic diagram illustrating a motor system according to an embodiment of the present disclosure. As shown in FIG. 6, the encoder 10 includes a communication interface 14 capable of communicating with a motor drive 30 and a host computer 40. The encoder 10 also includes a storage module 16, a sensor module 13.

The encoder 10 may also include a RTC module 18 providing time information, and a power selection module 17 capable of selecting the power supply source of the encoder 10 from the external power interface 171 and a battery interface 172 when the external power supply of the encoder 10 is switched on/off.

For example, when the external power supply is connected, the power selection module 17 may enable the external power interface to supply power to the encoder 10 and the RTC module 18, so as to ensure that the encoder 10 does not consume power of the battery when the external power supply is connected; when the external power supply is disconnected, the power selection module 17 may enable the battery interface 172 to supply power to the RTC module 18, so as to ensure that the RTC module 18 has continuous power supply when the external power supply is disconnected. The power selection module 171 may be implemented by circuits capable of select a power supply interface with a higher voltage.

In some embodiments, the real-time clock module 18 may be capable of counting date and time, e.g., relying on continuous power supply from a battery. The microcontroller unit 11 may be capable of recording a date and a time obtained from the real-time clock module 18 into a motor running record when the motor running record is stored. For example, when a motor running record is stored, the microcontroller unit 11 may obtain the current date and time (e.g., “2020-08-24 16:45:01” (Year-Month-Date hour: minute: second)) from the real-time clock module 18, and store the current date and time into the motor running record. By recording the date and time when each motor running record is stored, the encoder can provide clear date and time information about the records, thus facilitates understanding of the conditions of the motor by a technical person.

In some embodiments, the storage module 16 may also store a maintenance period of the motor; the microcontroller unit 11 may determining an accumulative running time which indicates a total time length the motor 20 has been running accumulatively since a previous maintenance using the date and time information provided by the real-time clock module 18, and providing a maintenance alert to a device in response to a determination that the accumulative running time of the motor reaches the maintenance period. In an example, the microcontroller unit 11 may update an accumulative running time by adding to the accumulative running time length a time duration between the time the motor is powered on and the time the motor is powered off using the date and time information provided by the RTC module 18 each time when the motor is powered on or off. After a maintenance, the accumulative running time may be reset in response to a signal or a message received, e.g., via a physical button provided by the encoder or from the host computer 40.

In some embodiments, the storage module 16 may also store service life of the motor; the microcontroller unit 11 may determining an accumulative service time which indicates a total time length the motor 20 has been running accumulatively since the motor 20 is put into use by using the date and time information provided by the real-time clock module 18, and providing a replace-motor alert to a device in response to a determination that the accumulative service time reaches the service life. In an example, the microcontroller unit 11 may determine the accumulative service time by adding to the current accumulative service time a time duration between the time the motor is powered on and the time the motor is powered off using the date and time information provided by the RTC module 18 each time when the motor is powered on or off.

In some embodiments, the storage module 16 may also store an expire date of the motor; the microcontroller unit 11 may also be capable of providing a replace-motor alert to a device in response to a determination that the date obtained from the RTC module 8 reaches the expire date. The expire date refers to the date the motor should not be used further.

In some embodiments, the microcontroller unit 11 may also be capable of detecting a voltage of the battery, and providing a replace-battery alert to a device in response to a determination that the voltage of the battery is below a pre-defined voltage threshold. The battery may be connected to a port (or pin) of a chip serving as the microcontroller unit 11. The microcontroller unit 11 may measure the voltage applied to the port. For example, the battery may be connected to a port with an A/D conversion function of the microcontroller unit 11, or may be connected to a port of the microcontroller unit 11 via a standalone A/D conversion component installed in the encoder 10. The pre-defined voltage threshold may be stored in the microcontroller unit 11 or in the storage module 16.

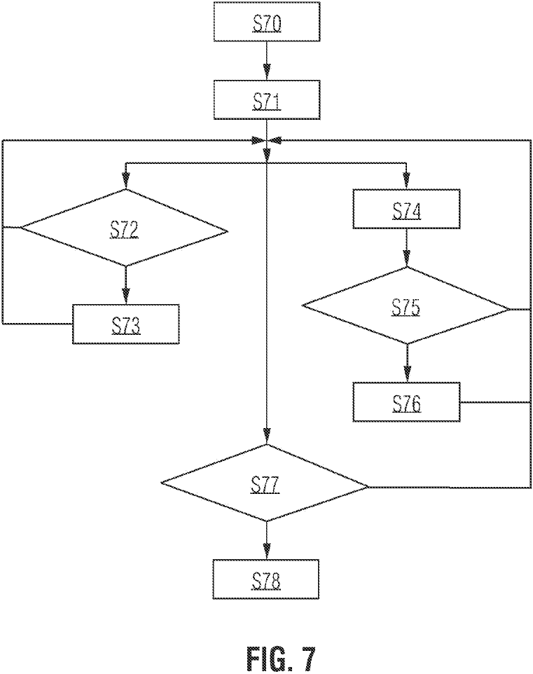

FIG. 7 is a flowchart illustrating a time-related alert functions of an encoder 10 with a real-time clock module 18 having a calendar function incorporating teachings of the present disclosure. As shown in FIG. 7, the method may include the following procedures:

At block S70, the RTC module 18 continuously updating the real-time date and time recorded in the RTC module 18.

At block S71, the encoder 10 is powered on, and the MCU 11 may begin continuously updating an accumulative running time of the motor 20 using clock signals of the RTC module 18.

At block S72, the MCU 11 may determine whether the accumulative running time reaches a maintenance period stored in the storage module 16.

At block S73, the MCU 11 may provide a maintenance alert in response to a determination that the accumulative running time reaches or exceeds the maintenance period.

At block S74, the MCU 11 may determine an accumulative service time of the motor 20 using a start-service date and time stored in the storage module 16 and the current date and time obtained from the RTC module 18. The start-service date and time may be set as the date and time when the motor 20 was manufactured.

At block S75, the MCU 11 may judge whether the accumulative service time reaches a service life stored in the storage module 16.

At block S76, the MCU 11 may provide a replace-motor alert in response to a determination that the accumulative service time reaches the service life.

At block S77, the MCU 11 may determine whether the encoder 10 is powered off.

At block S78, the MCU 11 may suspend updating the accumulative running time.

When using a motor drive 30 to drive a motor 20, configurations of the motor drive 30 should be done to match to the motor 20. Given the encoder 10 of various embodiments has the storage capability, the configuration process of the motor drive 30 may be simplified by taking advantage of the storage module 16 of the encoder 10.

In some embodiments, the storage module 16 may also store parameters of the motor; the microcontroller unit 11 may also be capable of providing the parameters of the motor stored in the storage module (16) through a communication interface in response to a parameter request received from the communication interface. The parameters of the motor 20 refer to basic information of the motor 20 required for the motor 20 to run properly. The parameters may include at least one of: rated voltage, rated current, rated power, rotation speed, rated torque, power efficiency, stall torque, stall current, power supply voltage, frequency, no-load current, or the like.

In some embodiments, the encoder 10 may also provide the parameters to a host computer 40 in response to a request from the host computer 40. By storing parameters of the motor, the encoder can provide the parameters on request, thus any device or person can obtain information about the motor from the encoder without keeping a hard copy of a manual of the motor after purchasing the motor.

In some embodiments, any of the parameters of the motor 20, the maintenance period of the motor 20, the service life of the motor 20 and the voltage threshold of the battery may be configured in the encoder 10 when manufactured.

In some embodiments, any of the parameters of the motor 20, the maintenance period of the motor 20, the service life of the motor 20 and the voltage threshold of the battery may be written in the encoder 10 by a host computer 40 of a manufacturer which integrates the encoder 10 into the motor 20. Other embodiments may adopt other possible methods to store those information into the encoder 10.

In some embodiments, the microcontroller unit may also be capable of, in response to a record restoring command received from a device, downloading motor running records from the device into the storage module as restored motor running records. As such, the encoder is capable of downloading motor running records in batch, which is useful when the encoder is installed in to a motor to replace a previous encoder, thus the history of the motor can be recovered in another encoder and will not be lost when an encoder in a motor is not working and replaced.

Various embodiments include a motor 20 which includes the encoder 10 incorporating teachings of the present disclosure. Such motors can provide history records of abnormalities, maintenance operations of the motors using encoders integrated in the motors, thus can eliminate the need of keeping manual notes by technical persons, maintenance and repair of the motors can benefit from the existence of such encoder 10 in the motors 20.

In some embodiments, there is a motor drive 30 which may include: a drive controller, capable of detecting an abnormality of a motor 20, and sending information about the abnormality to an encoder 20 which stores the information as a motor running record. It can be seen that, the motor drive can make abnormalities of the motor detected by the motor drive recorded in the encoder so as to be with the motor all the time and can be obtained whenever needed, thereby facilitates maintenance and repair of the motor.

In some embodiments, the drive controller may also be capable of sending a parameter request to the encoder 10, configures settings of the motor drive 30 using parameters returned by the encoder 10. By obtaining parameters of the motor 20 from the encoder 10 of the motor 20, the motor drive 30 can perform automatic self-configuration when connected to the motor 20 without manual configuration procedures, thus the configuration of the motor drive 30 can be simplified and less time-consuming.

Various embodiments include a host computer 40 which may include: a host controller, capable of sending a reading request to a communication interface of an encoder 10, and presenting at least one motor running record returned by the encoder 10 using a display device. The display device may be a component of the host computer 40 or a standalone display device. It can be seen that, the host computer can read running state records of the motor from the encoder and present the same, thereby facilitates maintenance and repair of the motor.

In some embodiments, the host controller may also be capable of receiving maintenance information from an input device, and sending the maintenance information to the encoder which stores the maintenance information as a motor running record. As such, the host computer 40 can record information inputted by a technical person into the encoder of the motor 20, e.g., the change of a part of the motor 20, or a certain maintenance operation done to the motor 20, to facilitate future maintenance or repair of the motor.

In some embodiments, the host controller may also be capable of reading all of motor running records from a first encoder, and storing the motor running records into the second encoder as restored motor running records. As such, when an encoder in a motor is not working and replaced, the host computer can read all the motor running records from the previous encoder and storing the motor running records into the new encoder, thus the history of the motor can be recovered in the new encoder and will not be lost.

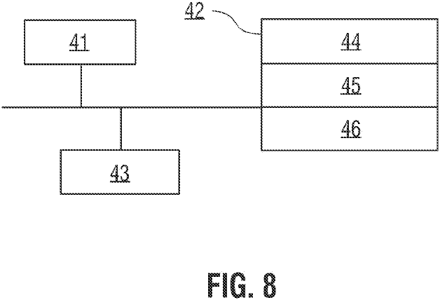

FIG. 8 is a schematic diagram illustrating a host computer 40 incorporating teachings of the present disclosure. As shown in FIG. 8, the host computer 40 may include a processor 41, a memory 42 and a communication module 43. The communication module 43 may include one or multiple physical communication interfaces for communicating with different devices, e.g., a motor drive 30, an encoder 10, a display device, an input device, or the like. The memory 42 may include an operating system 44, a communication processing module 45 for processing communication data, and a host controller 46. The host controller 46 may be implemented by computer-readable instructions. The processor 41 is capable of executing the instructions of the host controller 46 to implement the functions of the host computer 40 of various embodiments.

The teachings of the present disclosure include non-transitory computer readable storage media having stored therein one or more instructions, which, when executed by a computing device, cause the computing device to achieve at least some components of the above drive 30 or host computer 40. In particular, it may provide a system or apparatus equipped with a storage medium on which software program codes for realizing the functions of any of the above-described embodiments are stored, and a computer (or a CPU or an MPU of the system or apparatus) reads out and executes the program code stored in the storage medium. In this case, the program code itself read from the storage medium can realize the function of any one of the above-described embodiments, and thus the program code and the storage medium storing the program code constitute a part of the present disclosure. The non-transitory computer readable storage medium includes a hard disk, a floppy disk, a magnetic disk, a compact disk (e.g., CD-ROM, CD-R, CD-RW, DVD-ROM, DVD-RAM, DVD-RW and DVD+RW), a tape, a Flash card, ROM, and so on. Optionally, it is possible to download the program codes from a server computer via a communication network.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An encoder for a motor, the encoder comprising:
a sensor module for collecting sensor data of the motor with a sensor while the motor is running;
a storage module storing motor running records; and
a microcontroller unitprogrammed to determinea running state of the motor using the sensor data, storing information about the running state into the storage module as a motor running record in response to a determination that the running state is a pre-defined running state, and providing at least one of the motor running records stored in the storage module via a communication interface in response to a reading request received from the communication interface.

2. The encoder according to claim 1, wherein the microcontroller unit is programmed to receive a recording request from a device and store information specified by the recording request into the storage module as a motor running record.

3. The encoder according to claim 2, wherein:
the device comprises a drive of the motorand
the information specified by the recording request includes information about an abnormality of the motor detected by the drive.

4. The encoder according to claim 2, wherein:
the device comprises a host computer; and
the information specified by the recording request includes information about a maintenance operation on the motor generated by the host computer.

5. The encodeaccording to claim 1, wherein the microcontroller unit is further programmed to recordtime information indicating a time point programmed to when each motor running record is stored.

6. The encoder according to claim 5, wherein the microcontroller unitis further programmed to the microcontroller unit is further programmed to record an accumulative service time by counting clock signals of the microcontroller unit while the encoder is powered on, and into a motor running record the accumulative service time on record when storing the motor running record into the storage module.

7. The encoder according to claim 5, further comprising real-time clock module programmed to countdate and time;
wherein the microcontroller unitis capable of recording a date and a time obtained from the clock module into a motor running record when the motor running record is stored.

8. The encoderaccording to claim 1, wherein:
the storage module stores a maintenance period of the motor;
the microcontroller unit is further programmed to determine an accumulative running time which indicates a total time length the motor has been running accumulatively since a previous maintenance, and provide a maintenance alert to a device in response to a determination that an accumulative running time reaches the maintenance period.

9. The encoder according to claim 1, wherein
the storage module further stores service life of the motor;
the microcontroller unit is further programmed to determinean accumulative service time which indicates a total time length the motorhas been running accumulatively since the motor is put into use, and provide a replace-motor alert to a device in response to a determination that the accumulative service time reaches the service life.

10. The encoder according to claim 1, wherein:
the storage module further stores parameters of the motor ; and
the microcontroller unit is further programmed to provide the parameters of the motor stored in the storage module through a communication interface in response to a parameter request received from the communication interface.

11. The encoder according to claim 1, wherein the storage module comprises
a storage chip mounted to a circuit board of the encoder and connected to a serial communication interface of a chip serving as the microcontroller unit.

12. The encoder according to claim 1, wherein the storage module comprises storage circuits in a chip serving as the microcontroller unit.

13. The encoder according to claim 1, wherein_the microcontroller unit is further programmed to, in response to a record restoring command received from a device, downloadmotor running records from the device into the storage module as restored motor running records.

14. The encoder according to claim 7, wherein:
the real-time clock module comprises a real-time clock chip mounted to a circuit board of the encoder, and is connected to a serial communication interface of a chip serving as the microcontroller unit ;and
the circuit board includes a battery interface capable of delivering power from a battery to the real-time clock module.

15. The encoder according to claim 14, wherein_the microcontroller unit is further programmed to detect a voltage of the battery, and provide a replace-battery alert to a device in response to a determination that the voltage of the battery is below a pre-defined voltage threshold.

16. (canceled)

17. A motor drive comprising:
an encoder; and
a drive controller programmed to detect an abnormality of a motor and sending information about the abnormality to the encoder which stores the information as a motor running record.

18. The motor drive according to claim 17, wherein_the drive controller is further programmed to send a parameter request to the encoder and configuresettings of the motor drive using parameters returned by the encoder.

19. A host computer, comprising+ a host controller programmed to send a reading request to a communication interface of an encoder and presentat least one motor running record returned by the encoderusing a display device.

20. The host computeraccording to claim 19, wherein_the host controller is further programmed to receive maintenance information from an input device, and sendthe maintenance information to the encoder which stores the maintenance information as a motor running record.

21. The host computeraccording to claim 19, wherein_the host controller is further programmed to read all of motor running records from a first encoder, and storethe motor running records into the second encoder as restored motor running records.

22. (canceled)
